(19) United States
(12) Patent Application Publication
(10) Pub. No.: US 2022/0308271 A1
(43) Pub. Date: Sep. 29, 2022

(54) OPTICAL ELEMENT AND MANUFACTURING METHOD FOR OPTICAL ELEMENT

(71) Applicant: DAICEL CORPORATION, Osaka-shi (JP)

(72) Inventors: Hiroyuki HANATO, Tokyo (JP); Takahiro IWAHAMA, Tokyo (JP)

(73) Assignee: DAICEL CORPORATION, Osaka-shi (JP)

(21) Appl. No.: 17/701,150

(22) Filed: Mar. 22, 2022

(30) Foreign Application Priority Data
Mar. 23, 2021 (JP) 2021-048750

(51) Int. Cl. G02B 5/00; G02B 3/00; B29D 11/00

(52) U.S. Cl. CPC G02B 5/005; G02B 3/0031; B29D 11/00365; B29D 11/0048

(57) ABSTRACT

Provided is a technique that can suppress stray light incident on a microlens array from a gap between a lens component and a light shielding film and improve the imaging performance of the microlens array.

A light shielding film is provided around one or more lens components arranged at a base material portion having a substantially flat plate shape such that a predetermined gap region is formed with respect to at least a portion of an outer periphery of the lens component, and a surface roughened region having a surface roughness greater than that of another region in the base material portion is provided in at least a portion of the gap region.

### CROSS-REFERENCE TO RELATED APPLICATION

This application is based upon and claims the benefit of priority of the prior Japanese Patent Application No. 2021-048750, filed on Mar. 23, 2021, the entire contents of which are incorporated herein by reference.

### TECHNICAL FIELD

The present invention relates to an optical element and a manufacturing method for the optical element.

### BACKGROUND ART

In recent years, there has been an increase in the need for a fingerprint authentication function that is personal authentication using biometric information in a portable electronic device such as a smartphone. In particular, there is known a technique in which an optical fingerprint authentication sensor is arranged below a display unit of the portable electronic device, and thus the fingerprint authentication can be performed only by touching the display unit of the portable electronic device (see, for example, Patent Documents 1 and 2). In this optical fingerprint authentication sensor, scattered light from the fingertip is collected by a microlens array (optical element) below the display unit, and detection by an image sensor is performed to acquire the fingerprint pattern.

Then, to reduce noise light that passes through the microlens array and is incident on the image sensor and to increase the accuracy of image detection, it is necessary to form a light shielding film in the peripheral portion of each lens component (optical component) in the microlens array. However, since the accuracy of the formation position of the light shielding film is not sufficiently high, a gap between an end portion of the light shielding film and the lens component is necessarily sufficiently widened to prevent the light shielding film from reaching the lens component, and there is a disadvantage that noise light enters the microlens array from the gap.

### CITATION LIST

### Patent Document

Patent Document 1: JP 2020-135540 A
Patent Document 2: JP 2017-196319 A
Patent Document 3: JP S61-109002 A
Patent Document 4: JP 2006-337895 A
Patent Document 5: JP 4577584 B
Patent Document 6: JP 5813325 B
Patent Document 7: WO 2014/156915

### SUMMARY OF INVENTION

### Technical Problem

The technology of the present disclosure has been made in view of the above circumstances, and an object thereof is to provide a technique for suppressing stray light incident on an optical component from a gap between the optical component and a light shielding film and improving the imaging performance of the optical element.

### Solution to Problem

To solve the problems described above, an optical element according to the present disclosure is configured such that a light shielding film is provided around one or more optical components arranged at a base material portion having a substantially flat plate shape in a manner that a predetermined gap region is formed with respect to at least a portion of an outer periphery of the optical component, and a surface roughened portion having a surface roughness greater than a surface roughness of another region in the base material portion is provided in at least a portion of the gap region.

More particularly, an optical element according to the present disclosure includes one or more optical components arranged on at least one side of a base material portion having a substantially flat plate shape, a light shielding film provided around the optical component on a surface at which the one or more optical components of the base material portion are provided in a manner that a predetermined gap region is formed with respect to at least a portion of an outer periphery of the optical component, and a surface roughened portion provided in at least a portion of the gap region and having a surface roughness greater than a surface roughness of another region in the base material portion.

Here, the light shielding film may include an opening formed to surround at least a portion of the outer periphery of the optical component via the gap region, and the gap region may be a region sandwiched between a peripheral edge of the opening and the outer periphery of the optical component.

Further, the surface roughened portion may be also provided under the light shielding film on the surface at which the one or more optical components of the base material portion are provided.

Further, the surface roughened portion may be provided at a substantially entire surface excluding the optical component, on the surface at which the one or more optical components of the base material portion are provided.

A width of the gap region in a radial direction may be from 0.1 μm to 100 μm.

A manufacturing method for an optical element according to the present disclosure includes: integrally molding a base material portion having a substantially flat plate shape, one or more optical components arranged at a surface of the base material portion, and a surface roughened portion provided in a region surrounding the optical component, the surface roughened portion including a surface roughened, and then forming a light shielding film to surround, via a predetermined gap region, at least a portion of the outer periphery of the optical component, in which the surface roughened portion is provided in at least a portion of the gap region.

More specifically, an manufacturing method for an optical element according to the present disclosure includes: integrally molding a base material portion having a substantially flat plate shape, one or more optical components arranged at a surface of the base material portion, and a surface roughened portion provided in a region surrounding the optical component on the surface of the base material portion and including a surface roughened, and forming, after the molding, a light shielding film to surround, via a predetermined gap region, at least a portion of an outer periphery of the optical component on a surface at which the one or more optical components of the base material portion are provided, in which the surface roughened portion is provided in at least a portion of the gap region.

Here, the manufacturing method for an optical element may include integrally molding a base material portion having a substantially flat plate shape, and one or more optical components arranged at a surface of the base material portion, forming a surface roughened portion including a surface roughened in a region surrounding the optical component on the surface of the base material portion, and forming a light shielding film to surround, via a predetermined gap region, at least a portion of an outer periphery of the optical component on a surface at which the one or more optical components of the base material portion are provided, in which the surface roughened portion may be provided in at least a portion of the gap region.

Further, in the molding, the surface roughened portion may be molded using a surface roughened mold, by blasting in advance.

Further, in the forming of the surface roughened portion, the surface roughened portion may be formed by blasting.

Further, the light shielding film may include an opening formed to surround at least a portion of the outer periphery of the optical component via the gap region, and the gap region may be a region sandwiched between a peripheral edge of the opening and the outer periphery of the optical component.

Further, the surface roughened portion may be also provided under the light shielding film on the surface at which the one or more optical components of the base material portion are provided.

Further, the surface roughened portion may be provided at a substantially entire surface excluding the optical component, on the surface at which the one or more optical components of the base material portion are provided.

A width of the gap region in a radial direction may be from 0.1 μm to 100 μm.

Note that, in the present disclosure, as long as possible, techniques for solving the above-mentioned problems can be used in combination.

### Advantageous Effects of Invention

According to the present disclosure, a technique that can suppress stray light incident on an optical element from a gap between the optical component and a light shielding film and improve the imaging performance of the optical element can be provided.

### BRIEF DESCRIPTION OF DRAWING

FIG. 1A and FIG. 1B are schematic views of a microlens array.

FIG. 2A and FIG. 2B are flowcharts illustrating a manufacturing method for the microlens array.

FIG. 3 is a schematic view of a modification example of the microlens array.

FIG. 4 is a schematic view of a fingerprint authentication apparatus as an example of use of an optical module.

FIG. 5A and FIG. 5B are schematic views of the microlens array.

FIG. 6 is a schematic view of the known microlens array and photomask.

FIG. 7A and FIG. 7B are schematic views of the known microlens array.

### DESCRIPTION OF EMBODIMENTS

Hereinafter, a microlens array and a manufacturing method for the microlens array according to an embodiment of the present disclosure will be described with reference to the drawings. Note that each of the configurations, combinations thereof, and the like in the embodiment are an example, and various additions, omissions, substitutions, and other changes may be made as appropriate without departing from the spirit of the present disclosure. The present disclosure is not limited by the embodiments and is limited only by the claims.

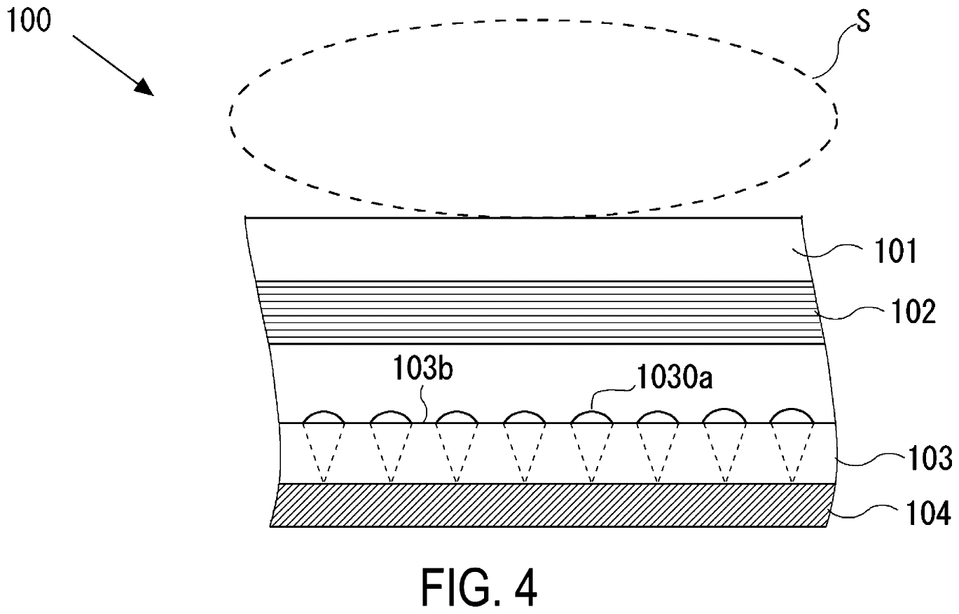

FIG. 4 illustrates an explanatory diagram of a fingerprint authentication apparatus 100 as an example of use of a microlens array according to the present embodiment. The fingerprint authentication apparatus 100 is an apparatus that authenticates a fingerprint and enables identity verification by a user placing a fingertip as an imaging target S on a display in a portable electronic device such as a smartphone.

The under-display type fingerprint authentication apparatus 100 includes a cover glass 101 in a display of the portable electronic device and an OLED (Organic Light Emitting Diode) 102 arranged in a lower layer of the cover glass 101, for example. This OLED 102 includes a light-emitting element (not illustrated), and has a light-emitting function. In addition, a microlens array 103 arranged below the OLED 102, and an image sensor 104 that captures an image of a fingerprint by detecting light collected by the microlens array 103 are included.

The microlens array 103 has a plurality of lens components 1030a as an optical component. The lens components 1030a are aligned one dimensionally or two dimensionally on a base material portion 103b having a substantially plate shape. The arrangement number and the alignment position of the lens components 1030a are not particularly limited, and are determined according to the size of the imaging target S and the size of the image sensor 104.

Each lens component 1030a collects, on the image sensor 104, light emitted from the OLED 102 and scattered by the imaging target S, for example. The image sensor 104 has an imaging plane at which a plurality of imaging elements are aligned one dimensionally or two dimensionally, and converts the collected light into an electric signal to generate a captured image. The image sensor 104 outputs the generated captured image to the information processing device (not illustrated). As the image sensor 104, for example, in addition to a photodiode, a CCD, a CMOS, an organic EL, a TFT, etc. may be used. By using the optical system including the microlens array 103 in the fingerprint authentication apparatus 100, the apparatus can be further miniaturized.

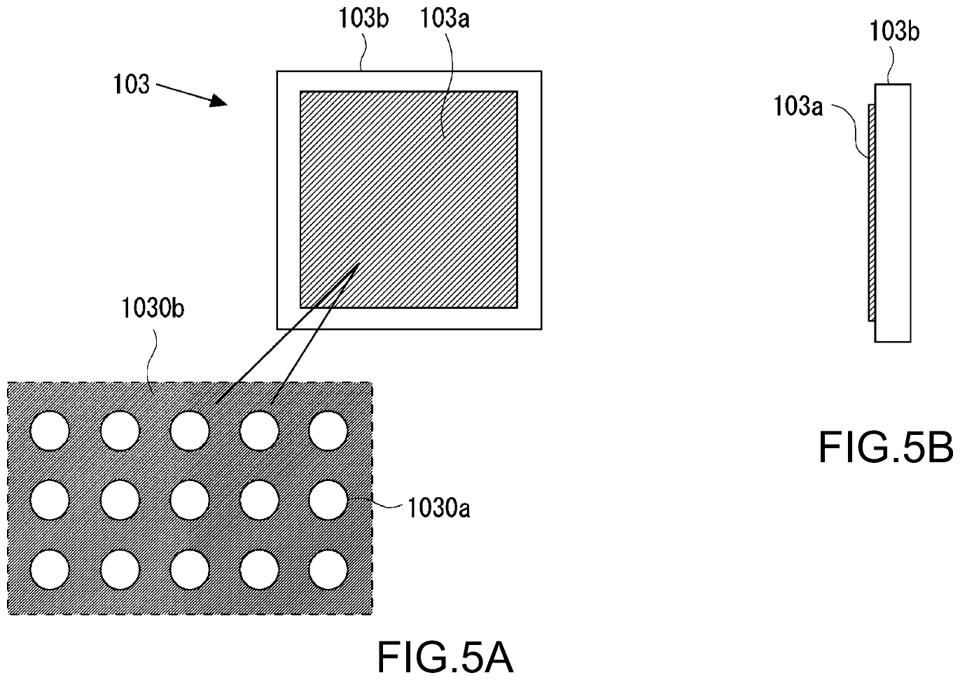

FIG. 5A and FIG. 5B illustrate schematic views of an example of the known microlens array 103. FIG. 5A illustrates a front view of the microlens array 103 and an enlarged view of a lens region 103a at which the lens component is aligned, and FIG. 5B illustrates a side view of the microlens array 103. The microlens array 103 is an optical element having the lens region 103a at which the small lens component 1030a having a diameter from approximately 10 μm to 100 μm is aligned, for example, on one side of the base material portion 103b having the substantially flat plate shape. The lens region 103a may be formed on both sides of the base material portion 103b, or may be formed at any position of the base material portion 103b.

The function and accuracy of the microlens array 103 vary depending on the shape (spherical, aspherical, cylindrical, hexagonal, etc.) of each lens component 1030a constituting the lens region 103a, the size of the lens component 1030a, the arrangement of the lens components 1030a, the pitch between the lens components 1030a, etc. The lens component 1030a in the microlens array 103 corresponds to an optical component of the present disclosure. The material of the microlens array 103 can include a resin material such as polycarbonate, PMMA, and cyclo-olefin copolymerization, but the type of material is not particularly limited.

Further, a light shielding film 1030b is provided around the lens component 1030a of the lens region 103a in the microlens array 103. In the fingerprint authentication apparatus 100, the light shielding film 1030b blocks light scattered by the fingertip as the imaging target S and incident on a portion excluding the lens component 1030a in the microlens array 103, and removes noise components (also referred to as noise light) in light reaching the image sensor 104. This improves the S/N ratio of the captured image generated by the image sensor 104, and can improve image quality.

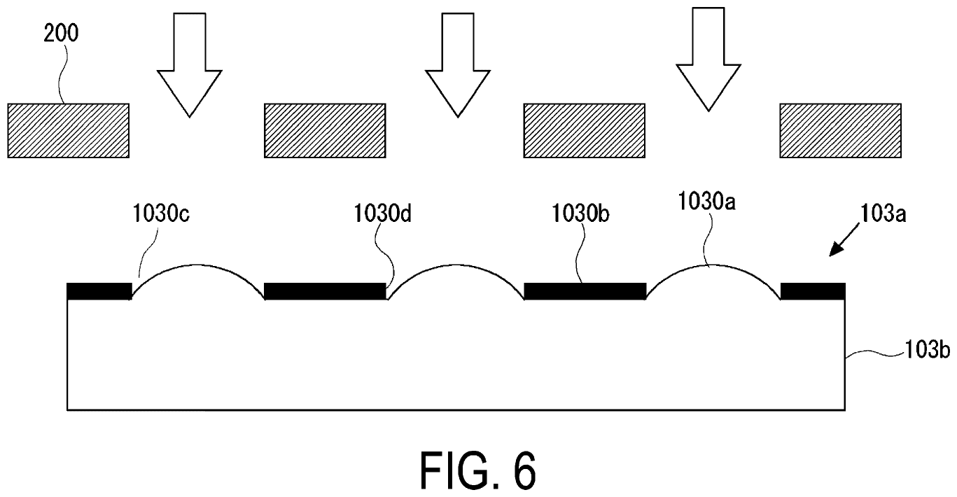

FIG. 6 illustrates a detailed cross-section of the lens region 103a of the microlens array 103 and a diagram for explaining the manufacturing process. The light shielding film 1030b in the microlens array 103 is provided by forming a light shielding photoresist film at the surface excluding the lens component 1030a in the base material portion 103b by, for example, a photolithography technique.

More specifically, a liquid photoresist material is applied to the surface of the base material portion 103b at which the lens components 1030a are formed, and exposure is performed in a state where, for example, a portion excluding the lens component 1030a is covered with a photomask 200. Then, by removing the exposed portion of the photoresist material by an etching process, the light shielding film 1030b made of the photoresist material is formed at a portion excluding the lens component 1030a in the base material portion 103b.

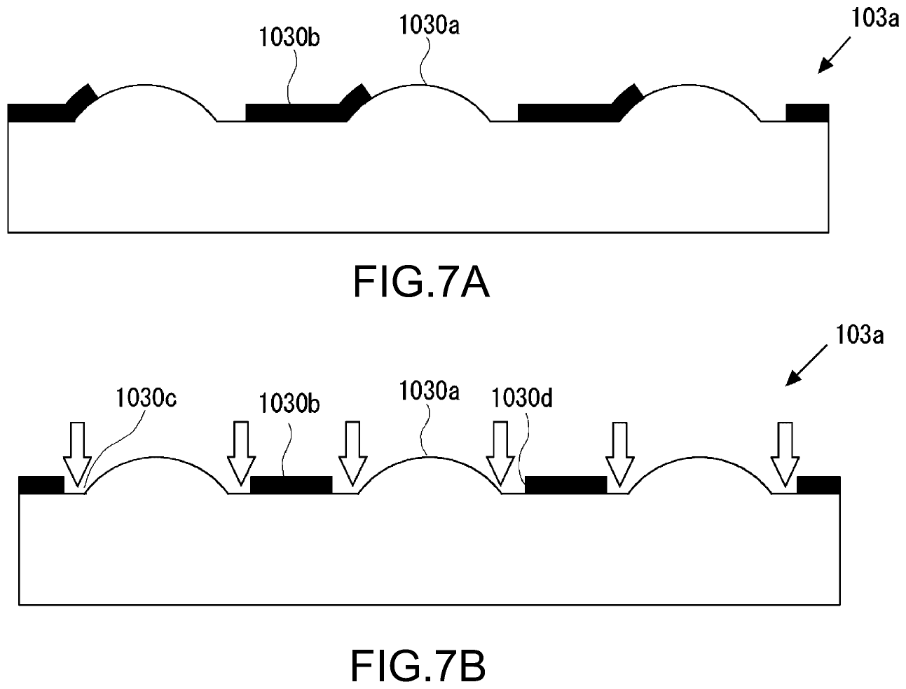

The light shielding film 1030b has an opening 1030c formed to surround the outer periphery of the lens component 1030a from the periphery. Preferably, a peripheral edge portion 1030d of the opening 1030c and the outer periphery of the lens component 1030a accurately match. However, in this case, due to the positional deviation between the microlens array 103 and the photomask 200 when forming the light shielding film 1030b, as illustrated in FIG. 7A, a portion of the light shielding film 1030b rides on the lens component 1030a, which may cause a disadvantage such as a decrease in light collecting performance by the lens component 1030a.

On the other hand, in the related art, the size of the opening 1030c in the light shielding film 1030b is set to be larger than the outer periphery of the lens component 1030a, and thus the light shielding film 1030b does not ride on the lens component 1030a even when the positional deviation between the microlens array 103 and the photomask 200 occurs. However, as a result, as illustrated in FIG. 7B, the scattered light from the imaging target S is incident from the gap between the peripheral edge portion 1030d of the opening 1030c of the light shielding film 1030b and the outer periphery of the lens component 1030a, and thus the image sensor 104 is irradiated with the scattered light. This may decrease the S/N ratio in the image sensor 104 and also the imaging performance.

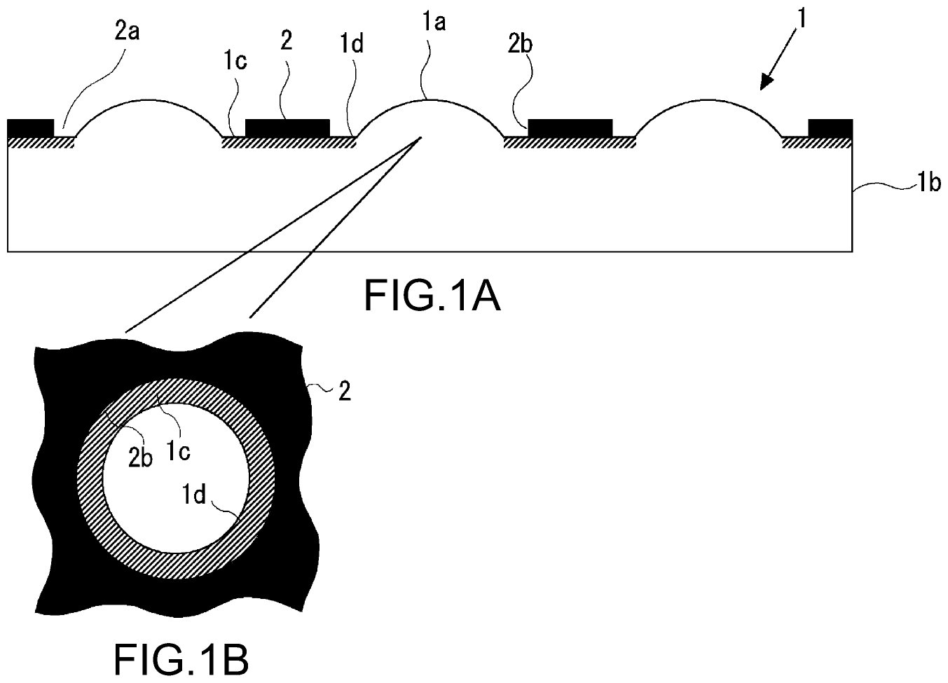

Next, FIG. 1A illustrates a cross-sectional view of a microlens array 1 in the present embodiment, and a plan view of the vicinity of a lens component 1a. FIG. 1A is a cross-sectional view of the microlens array 1, and FIG. 1B is a plan view of the vicinity of the lens component 1a. In the present embodiment, to solve the above-described problem, a surface roughened region 1c as a surface roughened portion is formed by roughening the surface of at least a gap region (hatched region in FIG. 1B) which is a region sandwiched between a peripheral edge portion 2b of an opening 2a of a light shielding film 2 and an outer periphery 1d of the lens component 1a by a blasting technique. Note that in FIG. 1B, the gap region occurs over the entire circumference of the outer periphery 1d of the lens component 1a, but depending on the positional relationship of the microlens array 1 and the light shielding film 2, decentering occurs between the peripheral edge portion 2b of the opening 2a of the light shielding film 2 and the outer periphery 1d of the lens component 1a. In this case, it is also conceivable that the peripheral edge portion 2b of the opening 2a of the light shielding film 2 and the outer periphery 1d of the lens component 1a come into contact and overlap. In such a case, the gap region in the present embodiment will occur with respect to a portion of the outer periphery 1d of the lens component 1a.

More specifically, in a mold for resin-molding the microlens array 1, a portion corresponding to the lens component 1a in the upper mold is covered with a mask, and then the surface is roughened by a blasting technique in which air containing an abrasive is made to collide. In the manufacturing process of the microlens array 1, the base material portion 1b, the lens component 1a, and the surface roughened region 1c are integrally molded with the resin molding.

After that, the light shielding film 2 is formed by the above-mentioned photolithography technique. Here, the outer periphery 1d of the lens component 1a may be defined as an intersection line between the lens surface and the surface of the base material portion 1b, or may be defined as a circumferential portion having an effective diameter that functions as a lens in the lens component 1a. In addition, the width of the gap region in the radial direction (i.e., the distance between the peripheral edge portion 2b of the opening 2a of the light shielding film 2 and the outer periphery 1d of the lens component 1a) may be from 0.1 μm to 100 μm. Preferably, the width may be from 0.5 μm to 50 μm. More preferably, the width may be from 1 μm to 30 μm.

Additionally, the region to be roughened as the surface roughened region 1c is preferably the entire region of the gap region which is a region sandwiched between the peripheral edge portion 2b of the opening 2a of the light shielding film 2 and the outer periphery 1d of the lens component 1a. However, the surface roughened region 1c may be formed for a portion of the gap region. In addition, the surface roughened region 1c may be formed on the lower side of the light shielding film 2. The surface roughened region 1c may be formed at an entire surface excluding the surface of the lens component 1a, on the surface of the base material portion 1b at which the lens component 1a is provided. Further, the surface roughened region 1c is defined as a region having a surface roughness greater than that of the other region in the base material portion 1b; however, the other region in the base material portion 1c may be the opposite surface or the side surface in the base material portion 1c, in a case where the surface roughened region 1c is formed at the entire surface excluding the surface of the lens component 1a, on the surface of the base material portion 1b at which the lens component 1a is provided.

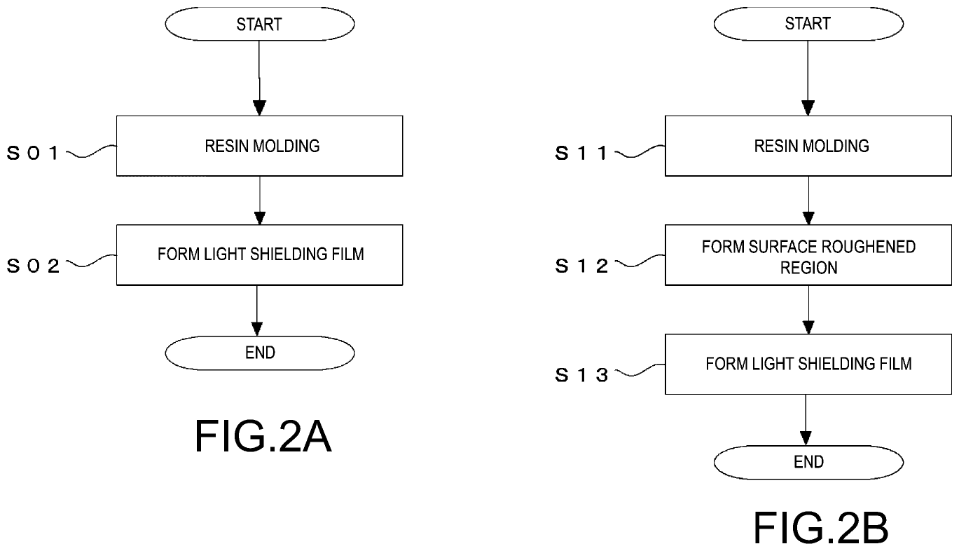

FIG. 2A illustrates the flow of the manufacturing process of the microlens array in a case where a surface portion corresponding to a surface roughened region 1c in the resin molding mold is roughened in advance as described above. When the flow starts, first, the lens component 1a, the base material portion 1b, and the surface roughened region 1c are integrally formed by resin molding with a mold, in S01. At this time, the surface portion corresponding to the surface roughened region 1c in the mold is roughened by a blasting technique in advance. The process of S01 corresponds to the molding in the present embodiment. Roughening the surface portion corresponding to the surface roughened region 1c in the mold by the blasting technique in advance corresponds to the blasting in the present embodiment.

Next, in S02, the light shielding film 2 is formed by the photolithography technique. At this time, the peripheral edge portion 2b of the opening 2a of the light shielding film 2 has a sufficient gap with respect to the outer periphery 1d of the lens component 1a, and in S02, even when the positional deviation of the microlens array 1 and the photomask 200 occurs, the light shielding film 2 does not ride up on the surface of the lens component 1a. Further, since the surface roughened region 1c is formed at the gap region between the outer periphery 1d of the lens component 1a and the peripheral edge portion 2b of the opening 2a of the light shielding film 2, the image sensor 104 can be suppressed from being irradiated directly with the noise light incident on the gap region and without being scattered. As a result, the decrease in the S/N ratio due to the noise light of the image sensor 104 and the decrease in image quality can be suppressed, and the accuracy of the fingerprint authentication can be enhanced. The process of S02 corresponds to the forming of the light shielding film in the present embodiment.

Note that in the manufacturing method for the microlens array 1, the base material portion 1b, the lens component 1a, etc. are integrally molded in the molding of the resin, and then a portion excluding the lens component 1a in the microlens array 1 may be roughened by the blasting technique. This process corresponds to the blasting in the present embodiment.

FIG. 2B illustrates the flow of the manufacturing method for the microlens array 1 in a case where the surface roughened region 1c is formed by the blasting technique after the resin molding of the microlens array 1 as described above. When the flow is started, first, the lens component 1a and the base material portion 1b are integrally formed by the resin molding with a mold in S11. The process of S11 corresponds to the molding in the present embodiment. Thereafter, in S12, the surface of the surface roughened region 1c in the microlens array 1 is roughened by the blasting technique. The process of S12 corresponds to the blasting in the present embodiment.

Next, in S13, the light shielding film 2 is formed at the microlens array 1 by the photolithography technique. The process of S13 corresponds to the forming of the light shielding film in the present embodiment. Also in this case, a sufficiently wide gap region is secured between the peripheral edge portion 2b of the opening 2a of the light shielding film 2 and the outer periphery 1d of the lens component 1a, and even when the positional deviation of the microlens array 1 and the photomask 200 occurs during the formation of the light shielding film 2, the light shielding film 2 does not ride on the surface of the lens component 1a. Further, since the surface roughened region 1c is formed at the gap region between the outer periphery 1d of the lens component 1a and the peripheral edge portion 2b of the opening 2a of the light shielding film 2, the image sensor 104 is suppressed from being irradiated with the noise light incident on the gap region and component without being scattered.

### Modification Example

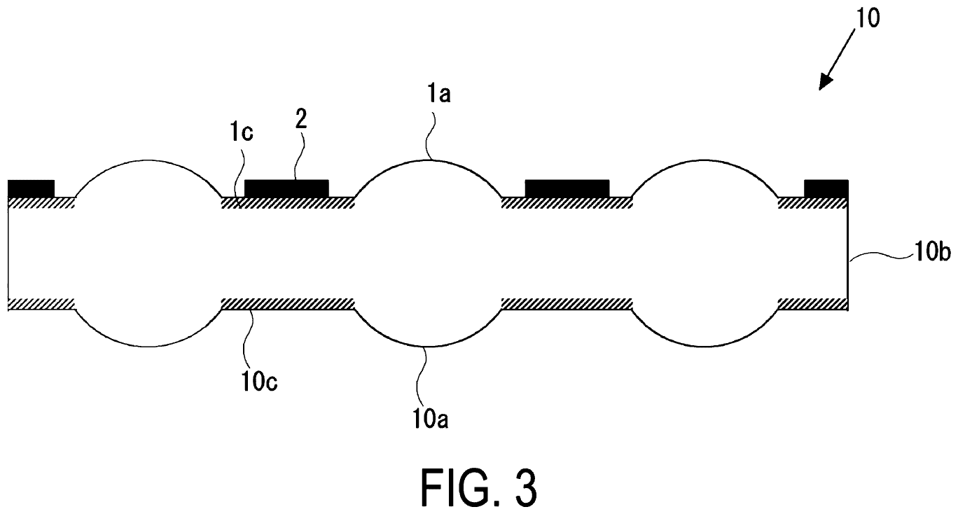

FIG. 3 illustrates a modification example of the present embodiment. A microlens array 10 according to this modification example is similar to the embodiment illustrated in FIG. 1A and FIG. 1B in that the lens component 1a, the surface roughened region 1c, and the light shielding film 2 are formed at the upper surface of the base material portion 10b. In the present modification example, the lens component 10a and the surface roughened region 10c are also formed at a lower surface of the base material portion 10b. In particular, the light shielding film 2 is not formed at the lower surface. This may be because noise light may be incident only from the upper side of the microlens array 10.

In this example as well, since the surface roughened region 1c is formed at the gap region between the outer periphery 1d of the lens component 1a and the peripheral edge portion 2b of the opening 2a of the light shielding film 2, the image sensor 104 is suppressed from being irradiated with the noise light incident on the gap region and without being scattered. Additionally, the surface roughened region 10c is also formed at the lower surface of the microlens array 10, and thus internal reflection in the microlens array 10 can be suppressed. As a result, the occurrence of flare or ghost due to the noise light in the microlens array 10 can be suppressed.

Note that a microlens array having a function equivalent to that of the microlens arrays 1 and 10 described in the present embodiment may be used as an optical system for image capturing other than fingerprint authentication, face authentication in security equipment, or space authentication in vehicles or robots. Further, in the present embodiment, the material of the microlens arrays 1 and 10 has been described on the premise that the material is a resin material, but the material of the microlens arrays 1 and 10 is not limited thereto. Other materials such as glass may be used. For example, a combination of a resin material and a glass material may be a combination of a structure in which a lens array of resin is affixed to a glass material. Also, glass molding may be employed instead of resin molding for the manufacturing method for the microlens array.

Also in the above embodiments, an example has been described in which the optical element is a microlens array having a lens component as an optical component, but the technique of the present disclosure may be applied to other optical elements of the microlens array. For example, it can be applied to an optical element including a diffraction grating component, a prism component, a mirror component, etc. as an optical component. In addition, in the embodiment described above, an example has been described using the blasting technique as a method for surface roughening, but the method for surface roughening is not limited thereto. A method of roughening the surface by altering the metal surface of the mold or the resin surface of the microlens array by a chemical method, a thermal method, or an optical method such as a laser may be used.

### REFERENCE SIGNS LIST

1, 10 Microlens array
1a, 10a Lens component
1b, 10b Base material portion
1c, 10c Surface roughened region
1d Outer periphery of lens component
2 Light shielding film
2a Opening of light shielding film
2b Peripheral edge portion of opening
100 Fingerprint authentication apparatus

1. An optical element comprising:
one or more optical components arranged on at least one side of a base material portion having a substantially flat plate shape;
a light shielding film provided around the optical component on a surface at which the one or more optical components of the base material portion are provided in a manner that a predetermined gap region is formed with respect to at least a portion of an outer periphery of the optical component; and
a surface roughened portion provided in at least a portion of the gap region and having a surface roughness greater than a surface roughness of another region in the base material portion.

2. The optical element according to claim 1, wherein
the light shielding film includes an opening formed to surround at least a portion of the outer periphery of the optical component via the gap region, and
the gap region is a region sandwiched between a peripheral edge of the opening and the outer periphery of the optical component.

3. The optical element according to claim 1, wherein
the surface roughened portion is also provided under the light shielding film on the surface at which the one or more optical components of the base material portion are provided.

4. The optical element according to claim 1, wherein
the surface roughened portion is provided at a substantially entire surface excluding the optical component, on the surface at which the one or more optical components of the base material portion are provided.

5. The optical element according to claim 1, wherein
a width of the gap region in a radial direction is from 0.1 μm to 100 μm.

6. A manufacturing method for an optical element, the method comprising:
integrally molding a base material portion having a substantially flat plate shape, one or more optical components arranged at a surface of the base material portion, and a surface roughened portion provided in a region surrounding the optical component on the surface of the base material portion and including a surface roughened; and
forming, after the molding, a light shielding film to surround, via a predetermined gap region, at least a portion of an outer periphery of the optical component on a surface at which the one or more optical components of the base material portion are provided, wherein
the surface roughened portion is provided in at least a portion of the gap region.

7. A manufacturing method for an optical element, the method comprising:
integrally molding a base material portion having a substantially flat plate shape, and one or more optical components arranged at a surface of the base material portion;
forming a surface roughened portion including a surface roughened in a region surrounding the optical component on the surface of the base material portion; and
forming a light shielding film to surround, via a predetermined gap region, at least a portion of an outer periphery of the optical component on a surface at which the one or more optical components of the base material portion are provided, wherein
the surface roughened portion is provided in at least a portion of the gap region.

8. The manufacturing method for an optical element, according to claim 6, wherein
in the molding, the surface roughened portion is molded using a surface roughened mold, by blasting in advance.

9. The manufacturing method for an optical element, according to claim 7, wherein
in the forming of the surface roughened portion, the surface roughened portion is formed by blasting.

10. The manufacturing method for an optical element, according to claim 6, wherein
the light shielding film includes an opening formed to surround at least a portion of the outer periphery of the optical component via the gap region, and
the gap region is a region sandwiched between a peripheral edge of the opening and the outer periphery of the optical component.

11. The manufacturing method for an optical element, according to claim 6, wherein
the surface roughened portion is also provided under the light shielding film on the surface at which the one or more optical components of the base material portion are provided.

12. The manufacturing method for an optical element, according to claim 6, wherein
the surface roughened portion is provided at a substantially entire surface excluding the optical component, on the surface at which the one or more optical components of the base material portion are provided.

13. The manufacturing method for an optical element, according to claim 6, wherein
a width of the gap region in a radial direction is from 0.1 μm to 100 μm.
